(19) United States
(12) Patent Application Publication
(10) Pub. No.: US 2017/0016656 A1
(43) Pub. Date: Jan. 19, 2017

(54) SYSTEM AND METHOD FOR REMOVAL OF CONTAMINANTS FROM REFRIGERANTS

(71) Applicant: SELEX ES LTD, Basildon Essex (GB)

(72) Inventors: Derek CRANVEY, Basildon Essex (GB); Roger DAY, Basildon Essex (GB); Terry NICHOLLS, Basildon Essex (GB)

(73) Assignee: SELEX ES LTD, Basildon Essex (GB)

(21) Appl. No.: 15/301,153

(22) PCT Filed: Mar. 26, 2015
(86) PCT No.: PCT/EP2015/056495

§ 371 Date: Sep. 30, 2016

(30) Foreign Application Priority Data
Apr. 2, 2014 (GB) 1405982.8

(51) Int. Cl. F25B 43/00; B01D 3/42; F25B 45/00; B01D 3/14; F25B 43/04; F25B 43/02

(52) U.S. Cl. CPC F25B 43/00; F25B 43/04; F25B 43/02; F25B 45/00; B01D 3/14; B01D 3/42

(57) ABSTRACT

A method and system for purifying contaminated refrigerants is described. The refrigerant is heated in a controlled manner to separate it into fractions, one fraction having the pure refrigerant and the remaining fractions containing the contaminants. The temperature of the refrigerant fraction output being closely monitored and controlled to ensure that it is the correct required fraction.

The invention relates to a system and method for removal of contaminants from refrigerants. More specifically but not exclusively it relates to a coolant recycling system for and a method of purifying contaminated coolant fluids enabling their re-use as virgin fluids in complex refrigerant systems or test equipment for such systems

Many components in complex sub systems of aircraft require cooling to enable satisfactory operation. The sub systems are cooled by passing a refrigerant through passages within the chassis of the aircraft; the refrigerant expands as it flows through expansion valves and absorbs heat from the chassis. One coolant in use is Refrigerant R245fa, 1,1,1,3,3 Pentafluoropropane. This takes the form of a pure fluid with a boiling point of 15.3° C. at 1 atmosphere. R245fa is one of the more expensive refrigerants with one kilogram costing upwards of 80 euro. The R245fa once used is disposed of with zero cost return to the owner. Virgin R245fa is supplied from the manufacturer with a certificated purity standard

When a cooled sub system in an aircraft, for example, is maintained or repaired it becomes necessary to remove the coolant fluid from the aircraft to recovery cylinders. These recovery cylinders may not be clean and may contaminate the coolant rendering it ‘waste’ such that it cannot be used again.

In the event of a catastrophic failure within the aircraft the refrigerant may become contaminated with debris and may even breakdown due to the action of overheating (acids). Again this results in contaminated coolant that must be removed from the aircraft to recovery cylinders and becomes classed as waste.

Furthermore, servicing of the coolant system of the aircraft can lower the purity of the coolant by introduction of contaminants again requiring the coolant to be disposed of as waste.

Contaminants can include non-condensables, oils, greases and water along with particulates, other refrigerants and acids.

Generally, non-condensables comprise air from the environment introduced by operators during the removal of the fluid from its host system and system leaks that allow air in at low temperature. Other non-condensables such as nitrogen and helium can be introduced due to poor purging of the system and the fluid handling equipment during testing.

It should be noted that coolants are very effective cleaners and, for example, R245fa will strip (leech) plasticizer oils from elastomeric seals in a coolant system. It has also been noted that manufacturers of systems components have used greases and oils in manufacture that are also stripped by the R245fa. It is also recorded that poor sealing on vacuum pump valves used in system preparation has also introduced oils into the systems. Therefore, oils and greases are commonly found as contaminants in coolant and refrigerant systems.

According to the invention there is provided a method of removing contaminants from refrigerants comprising the steps of heating the contaminated refrigerant in a controlled manner; using an isobaric process to isolate the refrigerant from the contaminants; and removing the contaminants by condensing or evaporating as required.

According to the invention there is further provided a system for removing contaminants from refrigerant, the system comprising a fractional distillation column the column comprising a heat source and a demister, the column comprising a gas outlet, in which the system is further provided with temperature measuring means and temperature control means, the measuring means for measuring the temperature of the gas output from the column and the temperature control means for controlling the temperature of the heat source in the column in response to signals received from the temperature measuring means, the temperature of the refrigerant being controlled to ensure that the gas output is the correct fraction.

In this way R245fa or any other refrigerant may be reclaimed and processed to at least the same purity standard as virgin coolant and overcomes the problems with the prior art methods and systems.

Preferably, the various component chemicals required for extraction are identified and removed at set points within a fractional distillation column or still. As the contaminants chemical constituents are unknown the best method would be to discriminate the R245fa against the unknowns or variables. Using a simple isobaric process and the known properties, it would be possible to isolate the R245fa from the contaminants. The contaminants could then be removed by either condensing or evaporating as required.

This method is made possible as the expected contaminants are known, or can be easily identified by analysis, and the system is less complex than previously known systems and methods.

The invention will now be described with reference to the following drawings in which:

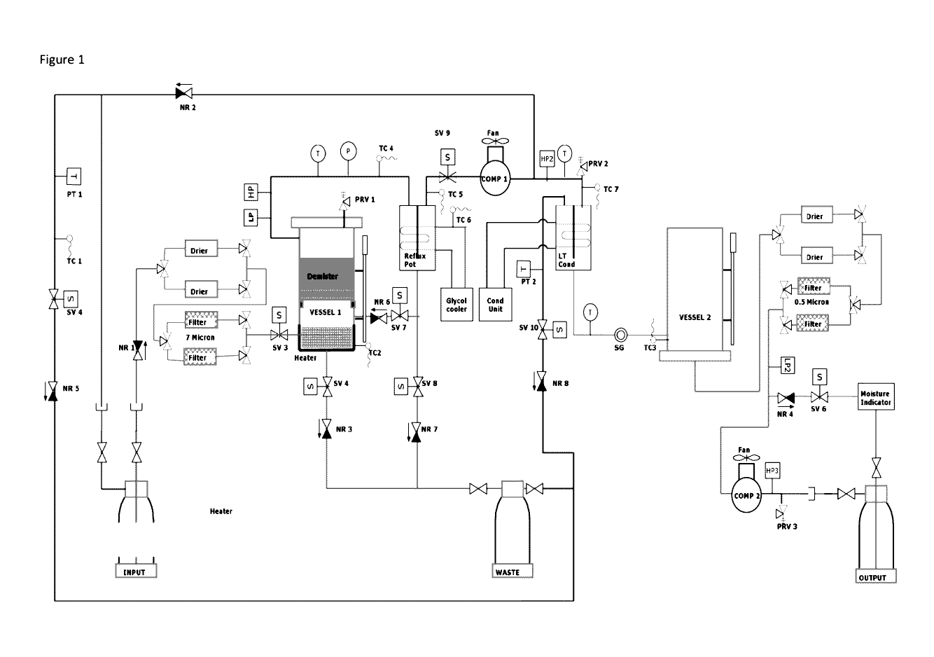

FIG. 1 shows a diagrammatic drawing of a reclaim unit including Vessel 1 in accordance with one form of the invention

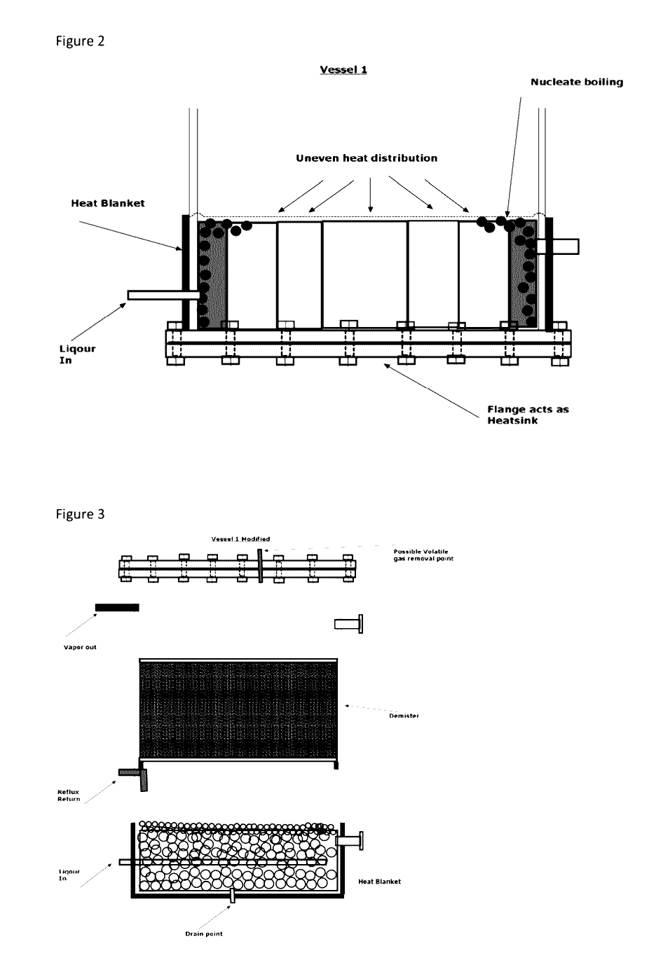

FIG. 2 is a diagrammatic drawing of one form of Vessel 1 of FIG. 1 shown in more detail;

FIG. 3 is a diagrammatic drawing of another form of Vessel 1 of FIG. 1 shown in more detail;

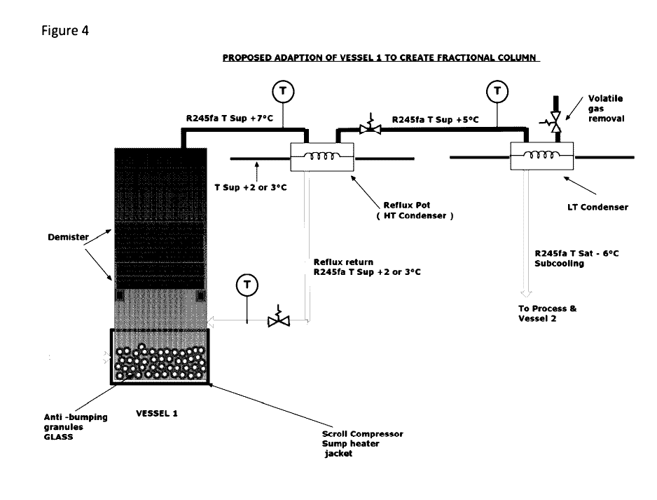

FIG. 4 is a diagrammatic drawing of another form of Vessel 1 in which the Vessel 1 of FIG. 1 has been modified to create a fractional column;

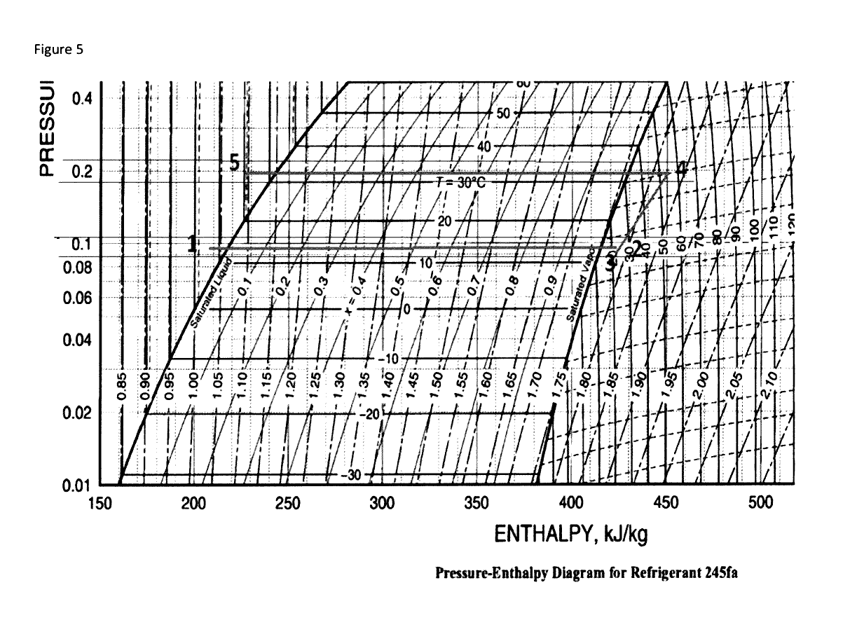

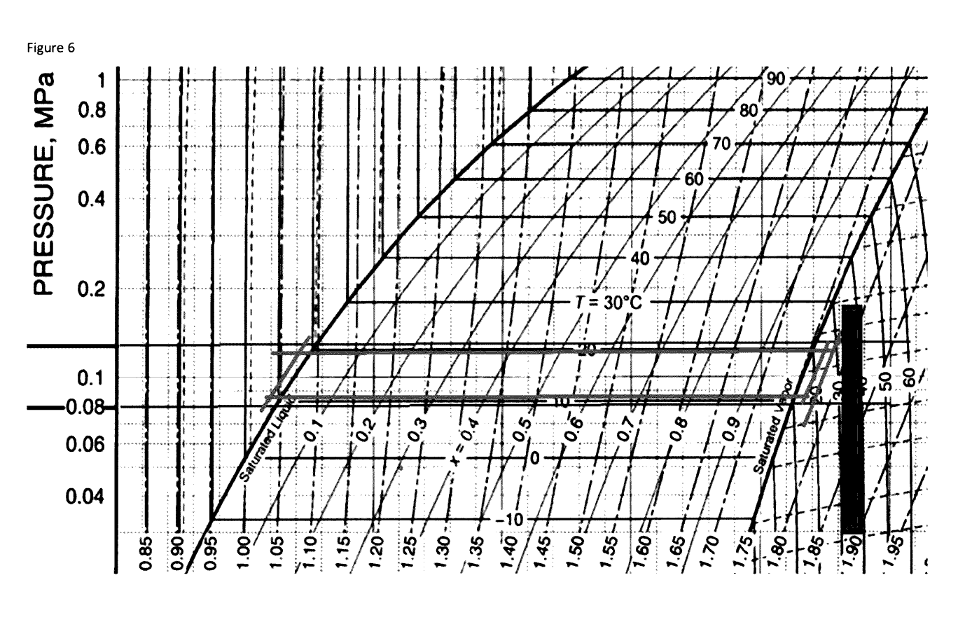

FIG. 5 is a P/E diagram of the process identifying specific points in the process;

FIG. 6 shows the phase changes of R245fa maintained within a barometric variable (−0.2 bar to +0.2 bar) against the vapour phase of 365 mfc, the thick horizontal lines showing the barometric variable, the parallelogram showing the R245fa phase change, the vertical block showing the 356 mfc liquid phase, and the short diagonal line showing the R245fa gas phase; and

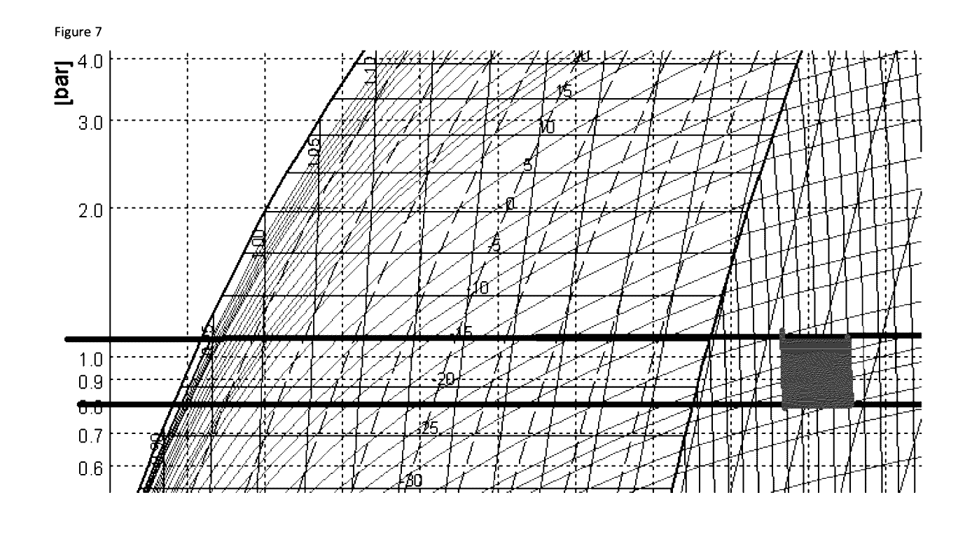

FIG. 7 shows the phase changes of R227ea maintained within a barometric variable (−0.2 bar to +0.2 bar) where the liquid phase of R245fa is shown as a shaded block

In the embodiment described below, the refrigerant referred to is R245fa. However, it will be appreciated that the method and system described may be applied to other refrigerants with simple modifications to the temperatures and pressure used.

The reclaim unit shown in FIG. 1 is used to purify waste R245fa and relies on a close control system that removes each contaminant group through a separate processing stage to return virgin quality refrigerant. Using the equipment described above, waste refrigerant R245fa is purified using an enclosed distillation process and could be seen as a double or triple distillate process ie; if the required purity is not achieved first pass, the cycle can be repeated to improve purity. It will be appreciated that the process is not discriminative, in that, during any simple distilling process some carry over is unavoidable, (if unknown contaminants have been introduced). Heating arrangements can give rise to nucleate boiling around the vessel walls, this coupled with an open solution surface may give rise to ebullient boiling further increasing the likelihood of droplet entrainment or succession. The result being that even though the temperature of the R245fa has been raised sufficiently to enter its gaseous phase it would still have the ability to carry vapour droplets of an entrained substance with a higher T Sup. Particularly relevant if the unknown substances have similar boiling points to R245fa. Conversely at the condensing point of the R245fa any entrained substance with a significantly lower T Sup will attach to the condensing droplets.

The various component chemicals required for extraction are identified and removed at set points within a fractional distillation column or still. As the contaminants chemical constituents can be unknown the best method would be to discriminate the R245fa against the unknowns or variables. Using a simple isobaric process and the known properties of it would be possible to isolate the R245fa from the contaminants. The contaminants can then be removed by either condensing or evaporating as required.

A first embodiment of Vessel 1 is shown in FIG. 2. The Vessel is designed to allow access to the internals for essential cleaning/sterilisation post or pre-processing. Access is afforded via a heavy flanged plate (bottom) bolted to a welded flange on the vessel. Various openings have been provided on the vessel walls, top face and flanged bottom. The openings allow for, liquor introduction, waste removal, level manometer and product delivery to process stage 2. Heat is introduced to the process by a low wattage heater blanket fixed around the lower vessel wall, the heating process is controlled by a thermostat measuring tank temperature (this was modified to measure product delivery temperature). However, the heavy flanged acts as a large heat sink. Control reaction will be slow and cyclic in that much of the heat input will go to heating the flange and additionally dissipation of heat built within the flange will be uncontrolled. Whilst the first embodiment of Vessel 1 may be used to purify waste refrigerant in the system shown in FIG. 1, it can be difficult to achieve complete contact with a heat blanket due to the nature of the bolting arrangement and shape of the flange. Additionally, heat distribution is not equally spread leading to uneven liquor heating and nucleate boiling.

A second embodiment of Vessel 1 is shown in FIG. 3, in which the Vessel of FIG. 2 is essentially inverted. The inversion of vessel 1 removes the heat sink caused by the flange arrangement and allows full skin contact of a bucket type heat blanket to provide an all-round controllable gentle heat source (FIG. 3).

The used R245fa is introduced to vessel 1 via a feed distribution pipe. The pipe allows for distribution across the vessel, aid mixing and prevents isolated hot or cold spots that would occur if the entry was a simple ‘pipe end’ passed through the vessel skin. Boiling stones (anti bumping chips) form a bed at the base of the vessel. The boiling stones prevent agitated or ebullient boiling of the liquid by providing minute nucleation sites thereby allowing the liquid to boil more evenly without becoming superheated or bumping. Normally these stones would be Teflon coated ceramic chips however to ensure there is less possibility of reactivity it is suggested glass anti bumping chips may be used instead.

Extensive investigations to identify the most efficient type of demister suggest that the best results of droplet removal on such a short column would be achieved using a stainless steel mesh. On traditional longer columns several types of droplet removal are implemented. The issue is that different substances form different droplet sizes and there are efficient methods used for individual differences. Normally a plated labyrinth would remove the larger droplets, Raschig or pall rings would remove medium droplets and a mesh would remove the rest. On larger columns the various methods are used to prevent demister logging or blockages, if a single mesh demister were to be used it would become liquid logged increasing system pressure and preventing gas passage.

The demister is designed to remove droplets of entrained higher T sup contaminants virtually eliminating the succession which was occurring pre-modification. The demisted gas leaves vessel 1 via an outlet toward the top of the column. It may be possible to use the opening which was originally the feed inlet. The discharged gas temperature is measured and used to control the heat input to ensure the gas is the fraction required. On leaving the vessel the gas passes to the splitting phase which removes any minute contaminants using a dual condenser arrangement. The process is illustrated in FIG. 4.

Waste R245fa is fed to Vessel 1 where it is gently heated to T Sup+7° C. (system is isobaric +0.2 to −0.2 bar), passing over a demister the gas is discharged to the Reflux Pot (HT Condenser). The Reflux Pot performs two functions, namely on process start up the Reflux Pot returns all produce to vessel one until the process stabilises and during processing the Reflux Pot condenses any entrained contaminants with a higher T Sup than the process fraction. The Reflux Pot may be discharged to Vessel 1 periodically using a solenoid valve operated by the control system.

Accurate cooling control is required, the cooling medium must be maintained @ T Sup+3° C. to maintain the fraction as a gas. Cooling is provided by a small Glycol cooling pack which gives a more stable temperature. The discharge from the Reflux Pot may, with further modification, be discharged to the waste vessel to prevent reflux return to the liquor.

On achieving system stabilisation a solenoid valve operated by the control system allows the gas to enter the LT Condenser. The LT Condenser changes the R245fa state to a liquid @ T Sat−6° C. where upon it passes to the final filtration and Vessel 2.

One issue remains, the removal of more volatile contaminants. In a traditional Fractional Still the more volatile gases (with a lower T Sup) would pass the fraction discharge to be removed further along the column. It should be pointed out that unless there is heavy contamination the amount of contaminant is likely to be minute. This issue may be resolved by maintaining very precise control over the conditions being used to condense the R245fa. By doing this it would be possible to remove these contaminants from the LT Condenser as a gas after the R245fa has been condensed.

A single stage compressor is installed to provide the ‘push-pull’ requirement for introducing the R245fa into vessel 1. It is possible to rely on natural flow alone but the process would be very slow so the addition of a compressor is preferred. Additionally, the installation of a compressor post fraction will improve the processing time. It is essential to maintain the pressure/temperature control within the boundaries identified in FIG. 3.

FIG. 3 shows the process diagrammatically on a P/E diagram identifying the following individual points:

Point 1 Entry to Vessel 1 (pressure −0.2 to +0.2 bar) temperature @ 12-15° C.

Point 1 to 2 Heat input to phase change (liquid-vapour)

Point 2 Fraction leaving Vessel 1 (pressure −0.2 to +0.2 bar) temperature @ 23-25° C.

Point 3 Reflux cooling (pressure −0.2 to +0.2 bar) temperature @ 21-23° C.

Point 3 to 4 Compression phase

Point 4 Fraction leaving compressor (pressure+0.9 to +1.1 bar) temperature @ 31-36° C.

Point 4 to 5 Heat removal to phase change (vapour-liquid)

Point 5 Liquid to Vessel 2 (pressure+0.9 to +1.1 bar) temperature @ 20-26° C.

With R245fa boiling at +15° C. careful monitoring of the system pressure temperature relationship is required to determine the ideal extraction point for each type of contaminate.

It will be appreciated that the invention described above may be applied to any contaminated refrigerant and is not necessarily limited to R245fa or to refrigerants used in aircraft or aircraft subsystems or associated test equipment.

The Fractional distillation process must be carefully controlled to ensure even heat application to the liquor in the still to eliminate nucleate boiling. The use of ceramic (glass) boiling/anti bumping chips will prevent ebullient agitation. Further droplet reduction could be enhanced by adoption of a demister. Additional control of carry-over may be required, this would be particularly important on process start up. To assist the control upon process start-up it is recommended that a reflux pot is used.

1. A method of removing contaminants from a refrigerant, the method comprising:
heating a contaminated refrigerant in a controlled manner;
using an isobaric process to isolate the refrigerant from the contaminants; and
removing the contaminants by condensing or evaporating as required.

2. A method according to claim 1 in which the isobaric isolation process comprises:
hybrid fractional distillation of the refrigerant.

3. A method according to claim 1 comprising:
measuring a temperature of gas output; and
controlling the temperature of the contaminated refrigerant during fractional distillation to ensure that a correct fraction is being output.

4. A system for removing contaminants from refrigerant, the system comprising:
a fractional distillation column having a heat source, demister, and a gas outlet;
temperature measuring means for measuring a temperature of a gas output from the column, and
temperature control means for controlling a temperature of the heat source in the column in response to signals received from the temperature measuring means, the temperature of the refrigerant being controlled to ensure that a gas output is a desired fraction.

5. A method according to claim 2 comprising:
measuring a temperature of gas output; and
controlling the temperature of the contaminated refrigerant during fractional distillation to ensure that a correct fraction is being output.
